(19) United States
(12) Patent Application Publication
(10) Pub. No.: US 2006/0113833 A1
(43) Pub. Date: Jun. 1, 2006

(54) METHOD AND APPARATUS FOR THE DISTRIBUTION OF BRAKE TORQUE ON A VEHICLE

(75) Inventors: Peter LINGMAN, Goteborg (SE); Anders Eriksson, Goteborg (SE); Mats Sabelstrom, Billdal (SE); Bengt Terborn, Olofstorp (SE)

Correspondence Address: NOVAK DRUCE & QUIGG, LLP, 1300 EYE STREET NW, 400 EAST TOWER, WASHINGTON, DC, 20005, US

(73) Assignee: VOLVO LASTVAGNAR AB, Goteborg (SE)

(21) Appl. No.: 10/908,805

(22) Filed: May 26, 2005

Related U.S. Application Data
(63) Continuation of application No. PCT/SE03/01764, filed on Nov. 13, 2003.

(30) Foreign Application Priority Data
Nov. 26, 2002 (SE) 0203498-1

(51) Int. Cl. B60T 13/74

(52) U.S. Cl. 303/3; 188/106 P

(57) ABSTRACT

Method and apparatus for distributing brake torque between at least a first and a second braking device on a motor vehicle having at least two wheel pairs. The first braking device is a friction brake which acts on at least one wheel pair and the second braking device acts on at least one driven wheel pair. The distribution of brake torque between the first braking device and the second braking device takes account of brake torque required and also the maximum brake torque the first braking device and the second braking device can deliver. The distribution of brake torque takes place when the vehicle is driven with a cruise control function.

### CROSS-REFERENCE TO RELATED APPLICATIONS

The present application is a continuation patent application of International Application No. PCT/SE2003/001764 filed 13 Nov. 2003 which was published in English pursuant to Article 21(2) of the Patent Cooperation Treaty, and which claims priority to Swedish Application No. 0203498-1 filed 26 Nov. 2002. Said applications are expressly incorporated herein by reference in their entireties.

### TECHNICAL FIELD

The present invention relates to a method and apparatus for distributing the brake torque between service brakes and auxiliary brakes in a vehicle when the vehicle is driven with a cruise control function.

### BACKGROUND OF INVENTION

It is known to arrange auxiliary brakes in a vehicle as a supplement to the service brakes of the vehicle.

Auxiliary brakes are used mainly in heavy-duty vehicles for the primary purpose of sparing the service brakes of the vehicle, especially when driving on long downhill gradients and it is desirable to brake in order to maintain fairly constant speed. By making use of the auxiliary brakes, the service brakes can be preserved so that, when the vehicle really has to decelerate very strongly, they can deliver maximum braking force. The service brakes have more powerful braking effect than auxiliary brakes, partly due to the fact that the service brakes are normally arranged on all the wheels on the vehicle. The auxiliary brakes normally act only on the driving wheels.

It is also known to differentiate between what are known as primary and secondary auxiliary brakes in a vehicle. Primary and secondary refers to the positioning of the auxiliary brake before or after the main gearbox of the vehicle. Examples of primary auxiliary brakes are ISGs (Integrated Starters and Generators) and retarders. A retarder is usually of the hydrodynamic retarder or electromagnetic retarder type. These are arranged between the engine and the main gearbox. A primary auxiliary brake can also consist of various types of engine brakes, for example a compression brake, an exhaust-gas brake or the basic friction of the engine. The braking energy in a compression brake and an exhaust-gas brake is converted mainly to heat, which is to a great extent dissipated via the cooling system of the engine, but it should be noted that a considerable part (roughly forty percent of the braking energy) accompanies the exhaust gases of the vehicle out through the exhaust system. The basic friction of the engine can be regulated by injecting a certain quantity of fuel into the engine so that output torque from the engine is, for example, zero. Another possibility is to disengage the engine from the rest of the drive line by means of a clutch arranged between the engine and the gearbox. In the present context, the terminology of “drive line” shall be taken to include the engine of the vehicle, and also transmission components coupled to the engine, right out to the driving wheels. Other controllable units coupled to the engine which influence the braking force from the engine are, for example, the radiator fan of the engine, the air-conditioning unit of the vehicle, the compressed-air compressor and other auxiliary units coupled to the engine. The braking effect a primary auxiliary brake can deliver is dependent on the engine speed, for which reason it is advantageous to maintain a relatively high engine speed when a primary auxiliary brake is used.

A secondary auxiliary brake, which is arranged somewhere after the main gearbox of the vehicle, usually consists of a retarder of hydrodynamic or electromagnetic type. The braking effect a secondary auxiliary brake can deliver is dependent on the speed of the vehicle because the auxiliary brake is mounted on the output shaft of the gearbox and is therefore proportional to the speed of rotation of the driving wheels.

An auxiliary brake of the hydrodynamic retarder type usually consists of an impeller (rotor) and a turbine wheel (stator). The rotor is coupled firmly to, for example, the propeller shaft of the vehicle and rotates with it. The stator is arranged firmly in a retarder housing in which both the rotor and the stator are enclosed. The retarder housing is connected to a container for oil. When oil is pressed into the retarder housing, it is set in motion by the rotor which presses the oil against the stator. As the stator cannot rotate, retardation of the oil flow occurs.

Braking of the rotor and the whole vehicle thus takes place. The brake torque is regulated by the quantity of oil in the retarder housing. The heat which arises when the oil brakes the rotor is usually dissipated via a heat exchanger coupled to the cooling system of the engine. This means that the retarder requires more cooling capacity from the cooling system of the engine compared with, for example, the abovementioned compression brake or exhaust-gas brake where a large part of the braking energy disappears directly out through the exhaust pipe. The maximum braking capacity of a retarder can usually be utilized only for shorter periods of time as the capacity of the cooling system is not sufficient.

An auxiliary brake of the electromagnetic retarder type usually consists of a stator in the form of electromagnets and a rotor in the form of soft-iron plates. The rotor is coupled to, for example, the propeller shaft of the vehicle, and the stator is mounted firmly in the vehicle. When current is supplied to the electromagnets, a braking torque arises on the rotor when it rotates. The braking energy is converted into heat on account of the eddy currents which are formed in the soft-iron plates. In the case of prolonged braking, the rotor heats up to such an extent that the formation of eddy currents decreases because the magnetic properties of the soft-iron plates are temperature-dependent, which leads to the braking capacity decreasing. In the case of prolonged use and maximum utilization of the capacity of the retarder, the braking capacity can in principle even disappear completely. The electromagnetic retarder is usually cooled by surrounding air.

When a vehicle is equipped with powerful auxiliary brakes, for example, both primary and secondary auxiliary brakes, or several of only the primary type, there is a great risk that the combined braking force will be so great that in certain situations some transmission components are subjected to stresses which exceed their maximum torque capacity. A method for controlling the auxiliary brake torque so that the drive line is not damaged is described in a parallel application.

Moreover, there is a great risk that the friction of the driving wheels against the roadway will not be sufficiently great in order to convey the entire brake torque down to the roadway without the wheels skidding. This can lead to both an extended braking distance for the vehicle and abnormal tire wear that can even result in parts of the tires being worn flat. Even when the friction of the driving wheels against the roadway is sufficiently great in order to convey the entire brake torque down to the roadway, this can result in unnecessarily great tire wear on the driving wheels when strong deceleration is required. A method for controlling the auxiliary brake torque so that tire wear is minimized is described in a parallel application.

U.S. Pat. No. 5,921,883 describes a method in which the brake torque from a compression brake is controlled as a function of the speed of the vehicle or the gear engaged for the purpose of not exceeding the torque capacity of a transmission component. This method does not take account of whether the braking force from the auxiliary brake is too great for the friction between the roadway and the driving wheels; that is to say, that the vehicle starts to skid.

A common situation is that a driver tries to utilize auxiliary brakes as much as possible, on the one hand to spare brake linings and on the other hand to preserve the service brakes. An experienced driver can, with the aid of engine revolutions, speed, cooling water temperature and by looking at the gradient of the hill, utilize an auxiliary brake to maintain a relatively high speed on a downhill gradient without overheating the cooling system of the vehicle.

Depending on whether the auxiliary brake is a primary and/or secondary retarder, the braking effect is also influenced by the engine speed and/or the speed of rotation of the driving wheels.

This can give a relatively high speed when the vehicle is equipped with a retarder. With only an engine brake, the driver has to maintain a considerably lower speed in order to ensure that the braking effect is sufficient for keeping the vehicle at a constant speed.

There are also occasions when the braking effect delivered by, for example, a primary and a secondary auxiliary brake is not sufficient, for example when the cooling water is too hot. Another occasion when the braking effect from a secondary auxiliary brake is not sufficient is when the vehicle is driven at low speed, for example on a curving road. On these occasions, it would be desirable for it to be possible to increase the braking effect. This can be done by utilizing the service brakes of the vehicle in a controlled way in order to increase the braking effect of the auxiliary brakes.

There is therefore a need for it to be possible to distribute the brake torque between service brakes and auxiliary brakes in a vehicle in a way which makes it possible to maximize the speed of the vehicle. This is the main object of the invention described below.

### SUMMARY OF THE INVENTION

An object of the invention is to provide a method and apparatus for distributing the brake torque between service brakes and auxiliary brakes in a vehicle when the vehicle is driven with a cruise control function.

In at least one embodiment, the invention takes the form of a method for distributing a brake torque between at least a first and a second braking device on a motor vehicle including at least two wheel pairs. The first braking device is a friction brake which acts on at least one wheel pair and the second braking device acts on at least one driven wheel pair. The distribution is achieved by virtue of the fact that the distribution of brake torque between the first braking device and the second braking device takes account of the brake torque that is required and also the maximum brake torque that the first braking device and the second braking device can deliver when the vehicle is driven with a cruise control function.

An apparatus configured according to the invention achieves the object by distributing the brake torque between service brakes and auxiliary brakes on a motor vehicle so that a maximum speed is achieved when the vehicle is driven on a downhill gradient.

By means of the method according to the invention, the brake torque is distributed between service brakes and auxiliary brakes on a motor vehicle automatically by account being taken of brake torque required and the maximum brake torque the first braking device and the second braking device can deliver when the vehicle is driven with a cruise control function. The advantage of this method is that the total braking performance of the vehicle can be increased without the vehicle having to be fitted with extra equipment and without safety margins being reduced.

In a first development or variation of the method according to the invention, the distribution of brake torque takes place so that the speed of the vehicle is maximized. The advantage of this is that a higher average speed is achieved.

In a second development of the method according to the invention, the distribution of brake torque takes account of the temperature of the service brakes. The advantage of this is that a sufficient safety level is ensured in all braking situations.

In a third development of the method according to the invention, the method selects the engaged gear of the vehicle. The advantage of this is to optimize the braking effect of the auxiliary brakes.

In a fourth development of the method according to the invention, the method predicts the brake torque requirement by, for example, using an electronic map and/or GPS. The advantage of this is that a higher average speed is achieved.

By means of the apparatus according to the invention, a control unit distributes the brake torque automatically between service brakes and auxiliary brakes on a motor vehicle so that a maximum speed is achieved when the vehicle is driven on a downhill gradient. The advantage of this apparatus is that the speed of the vehicle, when it is driven on a downward gradient, can be increased without safety margins being reduced.

### BRIEF DESCRIPTION OF FIGURES

The invention will be described in greater detail below with reference to illustrative embodiments shown in the accompanying drawings, in which:

FIG. 1 shows a diagrammatic vehicle with braking devices configured according to the invention; and

FIG. 2 shows a graph illustrating the relationship between road gradient, vehicle speed and brake torque distribution.

### DETAILED DESCRIPTION

The illustrative embodiments of the invention described below, including different variations (developments), are to be seen only as examples and are in no way to be limiting of the scope of protection of the patent claims. In the described embodiments, disk brakes are used as an example of service brakes. It should be understood, however, that the illustrative embodiments also apply to drum brakes.

Furthermore, the designation “wheel axle” is not only used for a physical, continuous axle, but also applies to wheels that are located on a geometric axis, even though the wheels are individually suspended.

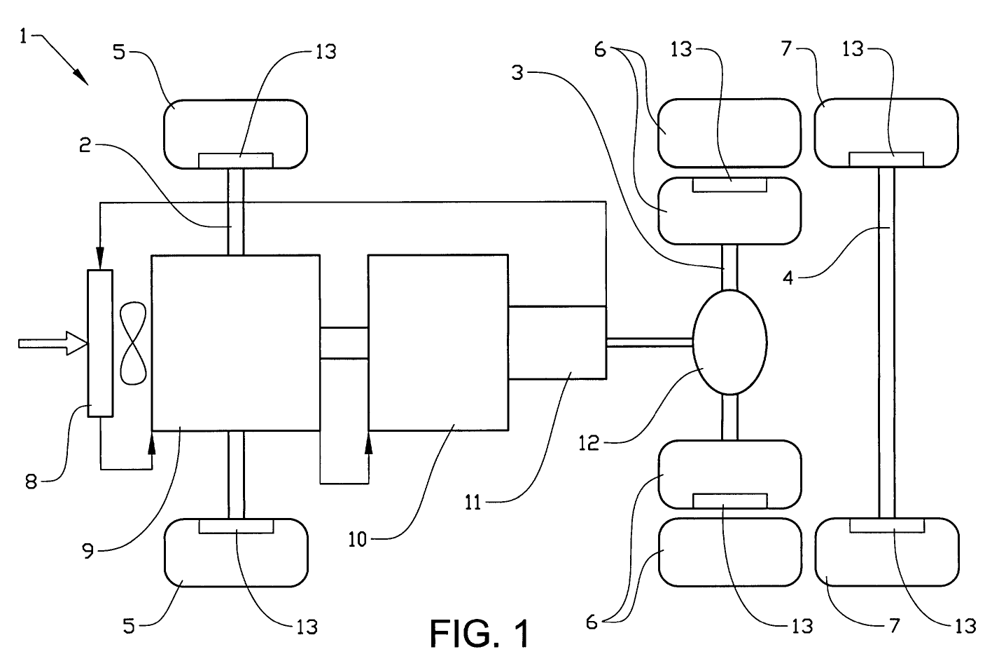

FIG. 1 diagrammatically shows a vehicle 1 with a front wheel axle 2, a first rear wheel axle 3 and a second rear wheel axle 4. Mounted on the front wheel axle 2 is a front wheel pair 5 which steers the vehicle. A first rear wheel pair 6 is mounted on the first rear wheel axle 3 which is also the driving axle of the vehicle.

The first rear wheel pair 6 consists of what is known as a twin mounting; that is to say, two wheels on each side of the driving axle. The second rear wheel pair 7 is mounted on the second rear wheel axle 4 that is a raisable axle which is used for heavy loads. Each wheel consists of a tire mounted on a rim.

Each side of a wheel axle is equipped with a service brake 13, exemplified in the form of compressed-air-fed disk brakes. The service brakes are controlled electronically with the aid of an electronic control unit (ECU) comprising (including, but not necessarily limited to) a computer (not shown). The service brakes can be controlled individually, for example in order to make active stabilization control (ESP=Electronic Stability Program) possible. The vehicle also comprises a radiator 8, an engine 9 with an auxiliary brake in the form of a compression brake (VEB=Volvo Engine Brake), a gearbox 10, a hydraulic auxiliary brake in the form of a retarder (CR=Compact Retarder) 11 and a final gear 12. These components are well-known to those skilled in the art, and therefore not described in greater detail.

A driver normally tries to utilize the auxiliary brakes as much as possible, especially on longer downhill gradients. A common driving strategy is to maintain a uniform speed of the vehicle using the auxiliary brakes and to use the service brakes only in order to achieve the speed at which the auxiliary brakes can maintain a uniform speed. One reason for this is that the driver does not want to wear brake disks and brake linings. Another reason is that the driver does not know how hot the service brakes are and therefore wants to be on the safe side as far as heat fading is concerned; that is to say, regarding the fact that the braking capacity of the service brakes decreases with increased temperature. This strategy results in the braking effect of the auxiliary brakes being utilized to the maximum, but at the same time the braking effect of the service brakes is not used at all. This means that the entire brake torque that brakes the vehicle has to be taken up by the wheels/tires on the driving axle, which in turn leads to disproportionately high wear on these tires. At the same time, it must be ensured that the brake torque does not exceed the maximum permitted torque that the drive line can handle.

In order to optimize the available brake torque, it is therefore advantageous to use both auxiliary brakes and service brakes and to distribute the brake torque between these braking devices in a suitable way. The distribution of brake torque can be carried out in different ways.

In a first illustrative embodiment of the method of the invention, the distribution of brake torque between auxiliary brakes and service brakes takes place by account being taken of the maximum brake torque the braking devices can deliver.

In this example, the required brake torque is first compared with the maximum brake torque the auxiliary brakes can deliver on a given occasion. As the brake torque that the auxiliary brakes can deliver is dependent on, among other things, engine speed and vehicle speed, at the same time as the drive line sets an upper limit for the maximum permitted brake torque. This comparison has to be made continuously in order to ensure that the brake torque required is delivered at the same time as the drive line is not overloaded. If the auxiliary brakes can deliver the required brake torque, the ECU ensures that all brake torque is distributed to the auxiliary brakes. If the auxiliary brakes cannot deliver the brake torque required, the ECU distributes that part of the brake torque required which the auxiliary brakes cannot deliver to the service brakes. The distribution of brake torque can of course also be carried out in other ways; for example, the service brakes can be brought into use when ninety percent of the brake torque of the auxiliary brakes has been reached. The braking effect of the service brakes should advantageously be adapted for each wheel axle, because the service brakes act on all the wheels while the auxiliary brakes act only on the driving axle. So as not to lock the wheels on the driving axle, the service brakes on the driving axle can therefore be activated with a lower braking force than the service brakes which act on non-driven axles.

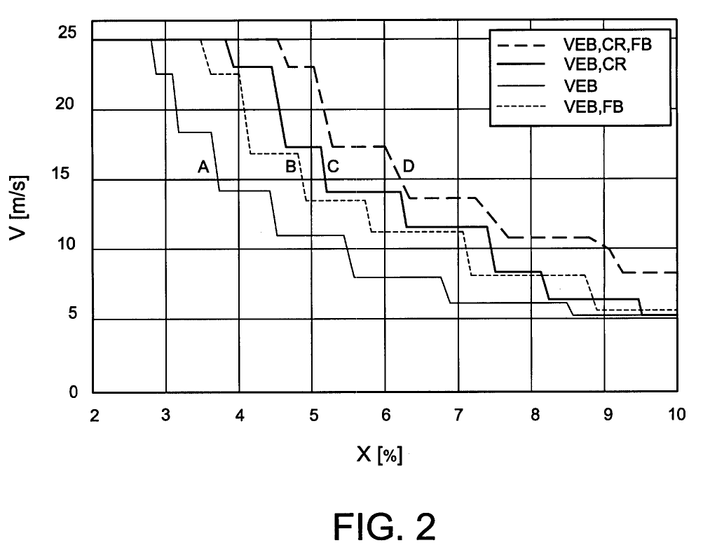

FIG. 2 shows how the maximum speed is influenced by the distribution of brake torque between the auxiliary brake(s) and service brake in the case of different road gradients in a fixed driving situation with a given vehicle combination. In this example, the vehicle combination weighs 60 tons and has 6 axles; that is to say, a truck with three axles and a trailer with three axles. The engine speed of the vehicle is 2200 rpm, the temperature of the brake disks is allowed to be 500° C., and the driving situation is continuous; that is to say, the vehicle is driven at a uniform speed with a cruise control function. The retarder is allowed to disengage when the cooling system becomes too hot.

The x-axis shows the road gradient in percent and the y-axis shows the speed (V) of the vehicle in meters per second. The curves show different combinations of braking devices. In curve A, the vehicle is braked using a compression brake VEB. In curve B, the vehicle is braked using a VEB and the service brakes. In curve C, the vehicle is braked using a VEB and a retarder. In curve D, the vehicle is braked using a VEB, a retarder and the service brakes. In FIG. 2, it can be clearly seen that the maximum speed at which the vehicle can be driven increases significantly when the auxiliary brakes are supplemented by the service brakes.

Moreover, it is clear that for a vehicle in which a VEB is combined with service brakes (curve B), an “on the whole” equivalent braking effect is obtained compared to the vehicle with a VEB and a retarder (curve C). This is advantageous for vehicles which require increased braking performance only occasionally, but where it is not economically justifiable, for example due to cost and/or weight, to equip the vehicle with a retarder.

FIG. 2 also shows that the braking effect for a retarder decreases at lower speeds. This can be seen from a comparison of the curves A and C. For a vehicle which is driven at low speed, for example on a steep curving road, it is therefore advantageous to distribute the brake torque between auxiliary brakes and service brakes in order to obtain increased braking performance.

The steps in the curves in FIG. 2 are due to the fact that the braking effect of the compression brake (VEB) is dependent on engine speed. At each step, the gearbox has been shifted down a stage in order to increase the speed of the engine and thus increase the braking effect of the compression brake. It is therefore advantageous for the gearbox that is used to be an electronically controlled gearbox so that an engine speed can be selected at which the braking effect is as high as possible.

In a second illustrative embodiment of the method according to the invention, the distribution of brake torque between auxiliary brakes and service brakes takes place by account being taken of the temperature of the service brakes. The temperature of each brake disk is measured by a suitable sensor or is estimated using a suitable algorithm. Depending on the temperature, the distribution of brake torque is adapted in order to avoid heat fading of the service brakes and in order to guarantee braking capacity for emergency braking. The temperature of a brake disk can be allowed to rise to, for example, 500° C. before the braking force is reduced.

In these illustrative embodiments, use is made of a calculation model in order to optimize the distribution of brake torque. This calculation model has, inter alia, the instantaneous road gradient as an input parameter.

When the gradient of the road changes while driving downhill, the control unit recalculates the brake torque distribution. Adequate safety margins must then of course be included in the calculation model so that the vehicle can always be braked to a standstill in an emergency situation.

In one version or development, use is made of the actual gradient as an input parameter. This can be done by using GPS and/or an electronic map in order to obtain the current position of the vehicle. With a map containing road profile and road gradient, the whole of the coming road gradient and road gradient changes can be used in order to determine the total brake torque requirement and thus an optimum distribution of brake torque between the auxiliary brakes and the service brakes. Here, a certain overspeed can be allowed in order to minimize the necessary braking.

In a first illustrative embodiment of the apparatus according to the invention, the apparatus comprises an electronic control unit (not shown) which provides control signals to the braking devices. Depending on the brake torque required, the brake torque is distributed between one or more auxiliary brakes acting on the driving axle and the service brakes which act on all the wheel axles. The exact distribution of the brake torque between the auxiliary brake and the service brake depends on which optimization algorithm is used. In this illustrative embodiment, the distribution is optimized so that the speed of the vehicle is maximized.

In order to optimize the distribution in a desired way, the control unit receives various input signals from the vehicle. Depending on the optimization algorithm, a number of different input parameters can be used. These can be one or more of the following: speed of the vehicle, acceleration of the vehicle, brake torque required, instantaneous brake torque, instantaneous retarder torque, weight of the vehicle, axle load, gradient of the roadway, retarder temperature, cooling water temperature, temperature of brake lining/brake disk/brake drum, atmospheric temperature, position of the vehicle. In the case of a vehicle combination consisting of a traction vehicle and a trailer, trailer-specific parameters can also be used in the calculation algorithm.

The invention is not to be regarded as being limited to the illustrative embodiments described above, but a number of further variants and modifications are conceivable within the scope of the patent claims. For example, it is also possible to distribute the brake torque between a traction vehicle and a trailer by taking account of the temperature of the braking devices of the trailer. This can be advantageous, for example, when the traction vehicle and the trailer have different brake linings.

What is claimed is:

1. A method for distributing brake torque between at least a first and a second braking device on a motor vehicle including at least two wheel pairs and wherein the first braking device is a friction brake that acts on at least one wheel pair and the second braking device acts on at least one driven wheel pair, said method comprising distributing brake torque between the first braking device and the second braking device when the vehicle is driven with a cruise control function engaged by taking account of required brake torque and maximum brake torque that the first braking device and the second braking device can deliver.

2. The method as recited in claim 1, wherein the distribution of brake torque between the first braking device and the second braking device maximizes the speed of the vehicle.

3. The method as recited in claim 1, wherein the distribution of brake torque between the first braking device and the second braking device is carried out so that the brake torque of the second braking device is utilized completely before the first braking device starts to deliver brake torque.

4. The method as recited in claim 1, further comprising taking account of the temperature of the first braking device in the torque distribution.

5. The method as recited in claim 1, further comprising reducing the braking force of the first braking device when its temperature exceeds a predefined value.

6. The method as recited in claim 1, further comprising adjusting the speed of the engine in order to optimize the braking effect of said second braking device.

7. The method as recited in claim 1, further comprising selecting the gear to be engaged so that the braking effect of said second braking device is optimized.

8. The method as recited in claim 1, wherein the first braking device is a service brake and the second braking device is at least one auxiliary brake.

9. The method as recited in claim 1, wherein input parameters for the method are at least one of the following: speed of the vehicle, acceleration of the vehicle, required brake torque, instantaneous brake torque, instantaneous retarder torque, weight of the vehicle, axle load, gradient of the roadway, retarder temperature, cooling water temperature, brake lining temperature, brake disk temperature, brake drum temperature, atmospheric temperature, and position of the vehicle.

10. The method as recited in claim 1, further comprising predicting the brake torque requirement by taking account of on-board stored information about the route lying ahead of the vehicle.

11. The method as recited in claim 1, further comprising predicting the brake torque requirement by taking account of GPS information.

12. The method as recited in claim 1, further comprising predicting the brake torque requirement by taking account of an electronic map concerning the route lying ahead of the vehicle.

13. The method as recited in claim 1, wherein said method is embodied in a computer program comprising program code for carrying out the steps of said method when executed by a computer.

14. The method as recited in claim 1, wherein said method is embodied in a computer program product comprising a program code stored on a computer-readable medium for carrying out the steps of said method when executed by a computer.

15. An apparatus for distributing brake torque between at least a first and a second braking device on a motor vehicle comprising at least two wheel pairs and wherein the first braking device is a friction brake which acts on at least one wheel pair and the second braking device acts on at least one driven wheel pair, and wherein said apparatus distributes the brake torque between the first braking device and the second braking device so that a maximum speed is achieved when the vehicle is driven on a downhill gradient.

16. The apparatus as recited in claim 13, wherein the first braking device is a service brake and the second braking device is an auxiliary brake.
